(19) United States
(12) Patent Application Publication
(10) Pub. No.: US 2022/0106545 A1
(43) Pub. Date: Apr. 7, 2022

(54) Method of Turning Food Waste into Wine

(71) Applicants: James Reilly, Wayne, NJ (US); Melissa Spigelman, Wayne, NJ (US)

(72) Inventors: James Reilly, Wayne, NJ (US); Melissa Spigelman, Wayne, NJ (US)

(21) Appl. No.: 17/494,079

(22) Filed: Oct. 5, 2021

Related U.S. Application Data
(60) Provisional application No. 63/088,472, filed on Oct. 7, 2020.

(51) Int. Cl. C12G 3/024

(52) U.S. Cl. CPC C12G 3/024; C12G 2200/15

(57) ABSTRACT

A method for preparing an alcoholic fruit wine from food waste is described. The method includes: inspecting and selecting raw fruit, boiling the raw fruit, crushing the raw fruit, transferring a crushed raw fruit pulp to a fermentation vessel, inoculating the crushed raw fruit pulp with a yeast to allow an initial fermentation to proceed within the fermentation vessel, adjusting a dissolved sugar content based on specific gravity to produce the alcoholic fruit wine having an alcohol by volume (ABV) in a range between about 7% to about 20%, separating fermented wine liquid from a solid fruit residue, allowing the fermented wine liquid to undergo a secondary fermentation in a new fermentation vessel to create an alcoholic fruit wine, inspecting the alcoholic fruit wine, and bottling the alcoholic fruit wine.

### CROSS-REFERENCE TO RELATED APPLICATIONS SECTION

This application is a U.S. Non-Provisional Patent Application that claims priority to U.S. Provisional Patent Application Ser. No. 63/088,472 filed on Oct. 7, 2020, the entire contents of which are hereby incorporated by reference in their entirety.

### FIELD OF THE EMBODIMENTS

The field of the invention and its embodiments relate to methods of converting food waste into a wine.

### BACKGROUND OF THE EMBODIMENTS

As much as 40% of all food goes to waste in America, estimated at 3.5 pounds of food a week per American. Americans throw out the food worth $165 bn per year, the equivalent of $1600 per family. The majority, 39% of this waste, is in the form of produce- with apples, bananas and berries being some of the largest offenders. 1 out of 7 truckloads of perishables delivered to supermarkets is thrown away. Supermarkets lose $15 bn annually in unsold fruits and vegetables. We are offering to take the wasted, forgotten, unloved fruits from your supermarket chains and industrial farms and to turn them into delicious wines. The problem we are solving is turning the leftover, uneaten, forgotten produce of your refrigerator into wine. We are using the ugly fruit that no one would buy at the supermarket, that in many cases supermarkets won't even bother to buy from farmers or that farmers won't even attempt to bring to market given consumer preferences for perfectly symmetrical, unblemished, still life-worthy produce. There is a need to take food wasted produce, and giving it new life, in the form of wine. By fermenting food waste into delicious, low calorie, low alcohol fruit wine; we aim to provide a unique drinking experience; one that the customer can feel good about because they are making the right decision for their body, their planet, and their future.

### REVIEW OF RELATED TECHNOLOGY

U.S. Pat. No. 10,463,063 teaches sweetened consumables and methods of forming said sweetened consumables that comprise certain sweeteners and a compound of formula (1),

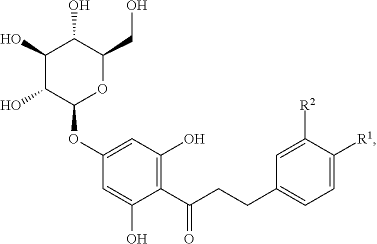

wherein R¹ is selected from the group consisting of OH and OCH₃, and R² is selected from the group consisting of H and OH, R¹ and R² comprise at least one OH group, and when R¹ is OH then R² is H (trilobatin), and when R¹ is OCH₃ then R² is OH (HDG), in a concentration near its sweetness detection threshold. The sweeteners include sucrose, fructose, glucose, high fructose corn syrup, corn syrup, xylose, arabinose, rhamnose, erythritol, xylitol, mannitol, sorbitol, inositol, acesulfame potassium, aspartame, neotame, sucralose, saccharine, or combinations thereof.

U.S. Pat. No. 9,789,142 relates to the field of nutraceuticals, and in particular to nutraceuticals comprising sulfated polysaccharides, Astragalus polysaccharides, resveratrol, and combinations thereof. These compositions find use in inducing physiological responses such, decreasing body fat, increasing lean body mass, alleviating the symptoms of colds, preventing the onset of colds, increasing energy, increasing the feeling of well-being in subjects, and improving skin tone and appearance.

U.S. Patent Publication No. 20020146493 discloses a decorative food formed of a plurality of kinds of fluid food materials and manufactured by using a mold is provided. The decorative food has an outside shape thereof conforming to an interior surface of the mold inclusive of an opening of said mold. The decorative food has a colored pattern divided into multiple divisions extending up to a central portion of the decorative food, in a direction to extrude the food materials into the mold, the colored pattern being formed such that the multiple divisions are arranged with substantially the same ratio at any of a cross sectional area intersecting the direction to extrude the food materials, and wherein the decorative food contains therein a foodstuff Also disclosed are an apparatus and method for manufacturing the decorative food.

U.S. Pat. No. 9,611,452 teaches a disposable winemaking apparatus for fermenting wine containing skins, seeds, and stems that form a cap includes a single-use, dual chamber plastic bag that incorporates a mechanism to agitate and disperse the cap in order to maximize extraction of color and flavor. It also includes an integral press mechanism to squeeze out the fermented juice through a strainer, retaining the pomace in the disposable bag. The device may also be used for racking and transfer of wine during aging.

None of the prior art teaches solves the problem of turning food waste into wine using methods and systems described herein.

### SUMMARY OF THE EMBODIMENTS

The object of the present invention comprises a method of producing fruit wine utilizing agricultural food waste. The object of the present invention is to provide a method for the manufacturing of fruit wines utilizing agricultural food waste as a starting material rather than grapes. The fruit waste would be collected from local farms and retail supermarkets, be frozen for storage and longevity, then boiled at high temperature (about >30° C.) for no less than about 30 minutes to destroy native yeast and bacteria common in food spoilage. Upon return to room temperature, the must (e.g., the freshly crushed fruit juice containing fruit skins, seeds, and stems) will be dosed with pectic enzyme, yeast nutrients and energizer, and the pH will be adjusted. The must will then be inoculated with strains of wine yeast and left to ferment about 7-10 days depending on the desired finish.

The object of the present invention comprises a fruit wine product beneficial to gut health and preparation method thereof. The present invention discloses a fruit wine product beneficial to the health of the gastrointestinal system and a preparation method thereof. The present invention utilizes the fermentation of fruit wines and methods borrowed from the manufacture of kombucha to produce a distinct alcoholic beverage of low alcohol content (about 4-8% ABV) which retains a symbiotic culture of bacteria and yeast (SCOBY). The SCOBY acts as both a potent pre- and probiotic supporting the growth and restoration of natural gut flora. In traditional winemaking once fermentation has completed the wine is racked (filtered) off the lees (deposits of dead yeast and bacteria). Our method instead retains the lees producing a sur lie wine beverage with increased probiotic content.

The object of the present invention comprises a Fruit wine product with antioxidant properties and preparation method thereof. The present invention discloses a fruit wine product containing high antioxidant composition, methods of production of such a fruit wine and methods for maintaining antioxidant concentrations during and post fermentation. Antioxidants are a class of molecules which inhibit oxidation. Antioxidant-rich fruits include blueberries, blackberries, raspberries, strawberries, cranberries, apples, cherries, pears, peaches, and plums. The production of fruit wine relies on the fermentation of natural sugars present in fruit by yeast to produce ethanol as a byproduct. By keeping a low alcohol content (about 4-8% ABV) and utilizing a steeping method for extraction of antioxidant polyphenols fruit wines can be produced with potent antioxidant properties.

The object of the present invention comprises a method of producing sour fruit wine. The object of the present invention is to provide a method for the manufacturing of fruit wines with a characteristic sour flavor reminiscent of sour beers. First, by starting off with a higher concentration of titratable acids the finished wine product will have a lower pH than traditional wines. Second, the use of specific yeast and bacterial strains: Lactobacillus and Pediococcus bacteria to produce lactic acid; Acetobacter to produce acetic acid; and Brettanomyces, a wild yeast, widely known for its ability to add sour notes to beer. The combination of these yeast and bacteria yield a distinctive wine flavor. Finally, subjecting the yeast to “cold-shock treatment” (the rapid decline in temperature from about 70-40° F., or 21-4° C.) will stress the yeast causing them to produce further sour flavor compounds and the cold-shock will additionally terminate fermentation and produce slight carbonation in the finished product.

The object of the present invention comprises a system for the production of fruit wine using restaurant food waste. The object of the present invention is to provide a system for the fermentation of fruit wines utilizing restaurant food waste as a starting material. The system would include a fermentation system capable of fermenting wine from whole fruit sources without the necessity of removing skins, or stems. The system would include a nylon mesh bag to keep the fruit solids separate from the liquid must. Additionally, it would contain an automated system for manipulating the cap to oxygenate the must periodically. Finally, included is a press mechanism for the purpose of pushing the fermented wine through a strainer, retaining the spent pomace in the nylon mesh bag.

### BRIEF DESCRIPTION OF THE DRAWINGS

FIG. 1 depicts a flowchart of a method to prepare an alcoholic fruit wine from food waste, in accordance with embodiments of the present invention.

### DESCRIPTION OF THE PREFERRED EMBODIMENTS

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim a limitation found herein that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

While many embodiments of the disclosure may be described, modifications, adaptations, and other implementations are possible. For example, substitutions, additions, or modifications may be made to the elements and the methods described herein may be modified by substituting, reordering, or adding stages to the disclosed methods. Accordingly, the following detailed description does not limit the disclosure. The present disclosure contains headers. It should be understood that these headers are used as references and are not to be construed as limiting upon the subjected matter disclosed under the header.

The present invention describes an alcoholic, fermented fruit beverage (or “fruit wine”) derived from food waste. The present invention allows for the creation of fruit wines in a plurality of flavors, where such flavors include apple, pear, banana, blueberry, blackberry, strawberry, raspberry, cantaloupe, watermelon, mango and less traditional seasonal fruits which see a large degree of waste, such as pumpkins, among other flavors not explicitly listed herein.

The present invention allows for the production of various wine styles and types, including: dry reds and whites that are full-bodied and have high levels of tannins and a medium acidity; medium-sweet reds and whites that are full-bodied and have medium levels of tannins and a medium acidity; sweet reds and whites that have low levels of tannins and a medium acidity; sour reds and whites that have low levels of tannins and a high acidity; and sparkling wines and champagne.

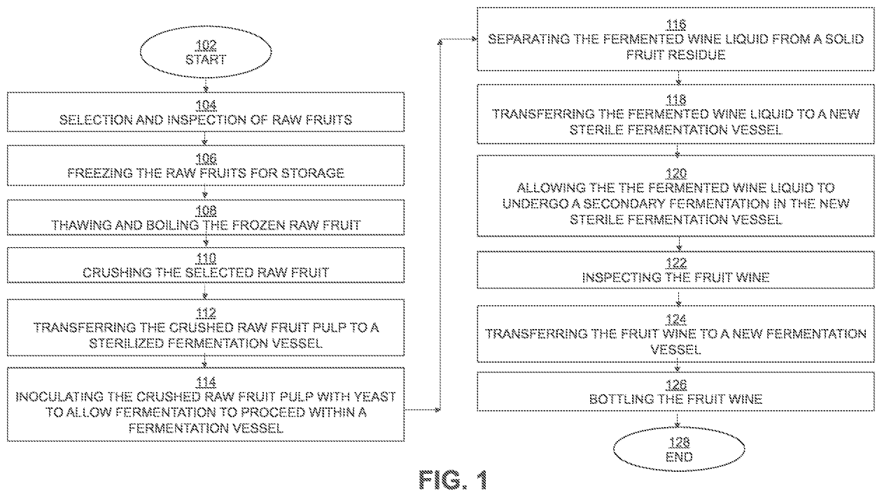

Specifically, FIG. 1 depicts a flowchart of a method to prepare an alcoholic fruit wine from food waste. Specifically, the method for brewing the fruit wine from agricultural, commercial, or consumer food waste of FIG. 1 is characterized in that the method includes a food waste derived fruit starting material rather than grapes.

The method of FIG. 1 begins at a process step 102. A process step 104 follows the process step 102 and includes selecting and inspecting raw fruit. At the process step 104, the raw fruit varieties used include, but are not limited to: pomegranates, apples, pears, banana, pumpkin, mango, watermelon, honeydew, and cantaloupe. The source of the raw fruit may be a commercial, agricultural or consumer food waste source, which may include: unsold grocery store produce, unsold agricultural products, blemished or damaged fruit matter which consumers do not purchase, and/or blemished or aged fruits which consumers or producers cannot utilize.

The fruit may be selected based on appearance, where fruit having an absence of mold or obvious contamination is chosen. Bruises, blemishes, and mushiness of the fruit are deemed acceptable for the raw fruit and all moldy, fungal or rotten fruit is discarded. After the raw fruit variety or combination is chosen, any fruit with obvious non-fermentable impurities are removed and the remaining fruit mass is washed.

A process step 106 follows the process step 104 and includes freezing the raw fruit to break down the cell walls of the raw fruit and storing the raw fruit until the raw fruit is ready to use. Some fruits, such as blueberries, blackberries, and raspberries, are immediately frozen.

Other fruits, such as strawberries, are destemmed and diced before freezing. Additionally, some fruits, such as bananas, are peeled before freezing. Further, some fruits are cored and diced before freezing, such as apples and pears.

A process step 108 follows the process step 106 and includes thawing and boiling the frozen raw fruit. A process step 110 follows the process step 108 and includes crushing the selected raw fruit. A process step 112 follows the process step 100 and includes transferring a crushed raw fruit pulp to a sterilized fermentation vessel.

As defined herein, “fermentation” refers a metabolic process that produces chemical changes in organic substrates through the action of enzymes. In the context of food production, “fermentation” may refer to any process in which the activity of microorganisms brings about a desirable change to a foodstuff or beverage. In microorganisms, fermentation is the primary means of producing adenosine triphosphate (ATP) by the degradation of organic nutrients anaerobically. As an example, fermentation may be used to produce alcoholic beverages, such as wine and beer.

A process step 114 follows the process step 112 and includes inoculating the crushed raw fruit pulp with yeast to allow for fermentation to proceed within the sterilized fermentation vessel. During this period, a dissolved sugar content is adjusted based on specific gravity (or SG) to produce wines ranging from about 7% to about 20% alcohol by volume (ABV).

It should be appreciated that “ABV” is a standard measure of how much alcohol is contained in a given volume of an alcoholic beverage. During fermentation, the yeast consumes the sugars of the crushed raw fruit pulp to produce alcohol. The density of sugar in the water is greater than the density of alcohol in the water. Moreover, a hydrometer is used to measure a change in the SG of the solution before and after the fermentation. The volume of the alcohol in the solution can then be estimated via numerous methods, where one such method includes the following:

ABV=136×(Starting SG−Final SG).

It should be appreciated that any method known to those having ordinary skill in the art may be used to estimate the volume of the alcohol in the solution.

Furthermore, during this process step, initial fermentation proceeds in a temperature range of at about 10° C. to about 50° C. In preferred examples, the initial fermentation proceeds in a temperature range of at about 15° C. to about 34° C. for a time period in a range of about 7 days to about 30 days depending on an ambient temperature. According to the present invention, primary fermentation is considered complete upon the fruit wine reaching a predetermined ABV as measured using SG and a detected decrease in fermentation activity, which can be visualized by a lack of robust, bubbling fermentation.

A process step 116 follows the process step 114 and includes separating the fermented wine liquid from a solid fruit residue. A process step 118 follows the process step 116 and includes transferring the fermented wine liquid to a new sterile fermentation vessel.

A process step 120 follows the process step 118 and includes allowing the fermented wine liquid to undergo a secondary fermentation in the new sterile fermentation vessel. At this process step, the secondary fermentation is maintained at a temperature of about 10° C. to about 50° C. In preferred examples, the secondary fermentation is maintained at a temperature in a range between about 15° C. to about 34° C. for an additional time period of about 14 days to about 28 days. SG readings are continually taken to monitor the secondary fermentation. Moreover, according to the present invention, the secondary fermentation is considered complete upon the SG reaching a predetermined level depending on the desired strength (e.g., ABV) for the specific fruit wine.

A process step 122 follows the process step 120 and includes inspecting the fruit wine aged in the process step 120. A process step 124 follows the process step 122 and includes transferring the fruit wine inspected in the process step 122 to a new fermentation vessel.

It should be appreciated that during the aging process, sedimentation is allowed and is monitored. Continued racking of the fruit wine product is utilized off to prevent off-flavors and to reduce an amount of sediment in the finished fruit wine product. In examples, the fruit wine can be aged for as little as about 1 month or for greater time periods, such as more than a year, depending on a desired finish of the fruit wine. Furthermore, in this process step, a final ABV is also calculated based on the SG.

A process step 126 follows the process step 124 and includes bottling the fruit wine. It should be appreciated that the “bottling” in this process step does not necessarily mean that the finished product is stored in a glass bottle, as the finished wine product may be stored in bottles, may be canned or may be tetra packed to preserve flavor and aroma of the fruit wine. The final fruit wine product is stored in an absence of oxygen to promote continued aging without the loss of flavor and the preservation and maturation of natural compounds therein.

A process step 128 follows the process step 126 and ends the method of FIG. 1.

In a preferred embodiment of the present invention, equipment to prepare the fruit wine via the method of FIG. 1 may comprise: fermentation buckets, preferably sized at 2 gallons and 7.9 gallons (e.g., 7.57 L and 29.91 L); mesh strainer bags; wooden spoons; a potato masher; measuring cups; funnels and a solution for sanitization solution. It should be appreciated that though any sized fermentation buckets may be used.

In a preferred embodiment of the present invention, a formulation for creating the fruit wine via the method of FIG. 1 includes: fruit (e.g., preferably 5 lbs. or 2267 grams per gallon of water), sugar (e.g., preferably 0.5 to 1 lb. or 226 to 453 grams per lb. of fruit, although this can vary depending on the fruit), water, white raisins (e.g., preferably 0.5 lb. or 226 grams per gallon of water), campden tablets, yeast nutrient, an acid blend, a tannin blend, although this can be an optional ingredient, and a pectic enzyme.

### EXAMPLES

Specific examples using the process steps of the method of FIG. 1 are described herein.

### Example 1

### Day 1

On a first day, this preparation may include thawing the fruit for about 1 to about 2 hours. Then, all equipment may be sanitized and allowed to soak in a solution for about 60 seconds. The equipment may be dried. The solution may include an acid-based, no-rinse, contact sanitizer.

Next, water is brought to a boil. Once the water has begun to boil, sugar is added to the water and stirred until the sugar dissolves. The sugar is added to adjust an initial sugar content of the raw fruit to an acceptable and fermentable level. Once the sugar is dissolved, the raw fruit is added to mesh bags and the mesh bags are placed into the fermenter.

Next, white raisins are added to provide body to the fruit wine. The white raisins may improve a mouth-feel of the fruit wine by increasing its viscosity. This gives the fruit wine a heartier, overall impression. It also causes the fruit flavors to linger on the tongue longer, producing a fruitier impression.

Then, the boiling water is poured over the fruit and is let steep for about 30 minutes. The fruit may then be macerated using a potato masher. Such maceration may include breaking the skins of the raw fruit to release the fruit juices. The fruit solids are not mashed into a smooth consistency. Then, the fruit sits for about one hour.

Next, crushed campden tablets are added. In preferred embodiments, 1 crushed campden tablet is added per gallon (or per 3.78 L) of wine. The campden tablet is a potassium or sodium metabisulfite tablet used to sterilize the fruit wine. Specifically, the campden tablet releases sulfur into the solution, killing bacteria and inhibiting growth of wild yeasts.

A yeast nutrient, a yeast energizer, and optionally a tannin blend is added, preferably 1 tsp (or 4.2 grams) per gallon of fruit wine. The yeast nutrient and the yeast energizer include nutrients necessary for yeast growth and survival that might not be found at adequate levels in non-grape fruits. Further, tannis is a naturally occurring polyphenol compound found inside grape skins, seeds and stems. The polyphenols release from the skins, seeds and stems when they soak in the grape juice just after the grapes have been pressed and are responsible for the characteristic dryness or astringency of wines particularly red wines.

Then, about 0.5 tsp (or 2.1 grams) of an acid blend is added per gallon. The acid blend is a blend of tartaric, malic and citric acids used to adjust the pH of the wine to the acceptable range of about 2.5 to about 4.5. The titratability acidity for non-grape white wines ranges from about 0.55% to about 0.65%. The titratability acidity for non-grape red wines ranges from about 0.50% to about 0.60%.

Next, about 0.5 tsp (or 2.1 grams) of pectic enzyme is added per gallon. The pectic enzyme physically breaks down pectins, a polysaccharide found in plant cell walls, which constitute the “fleshy” part of most fruits such as grapes, and apples. Adding it to the fruit wine breaks down the pulp, making pressing more efficient. Further, the solution sits overnight and is loosely covered with a paper towel soaked in a sanitizer.

### Day 2

In a preferred embodiment of the present invention, the method for the primary fermentation further requires the following equipment: a sanitization solution; airlocks; a measuring cup; a graduated cylinder; a hydrometer; a funnel; a cup; a spoon and carboys. The formulation comprises the following elements: yeast, wine and sugar.

In a preferred embodiment of the present invention, on Day 2, preparation of the fruit wine further comprises the following steps: sanitizing all equipment; removing about 1 to about 1.5 cups (e.g., 0.23 L to about 0.35 L) of wine from each wine; microwaving the cups of the fruit wine for about 30 seconds until warm at about 100° F. (or 37° C.); adding about 2 tbsp (or 25 grams) of sugar and stirring into the warmed wine; adding about 1 packet of yeast per 5-gallons (or 18.9 L) of fruit wine into the cup; allowing the yeast to rehydrate for about 30 min such that it will become bubbly and frothy; transferring the rehydrated yeast to the fermentation vessel; and letting the solution sit for about 1 hour.

Further, the hydrometer may be used to take SG readings and record the SG readings for each wine. This first SG reading is known as the Original Gravity (OG). The OG of a fast ferment sweet finish fruit wine should be about 1.080. Additional sugar may be added to increase the OG reading to the desired reading.

### Days 3-8

Between Days 3-8, the following process steps occur: sanitizing all equipment, punching a cap every 12 hours, stirring to reoxygenate the fruit wine, and letting the fruit wine ferment for about 5 days. On Day 8, the fruit solids are removed and either frozen for future use or disposed of for composting purposes. Also, on Day 8, a second SG reading is taken. This second SG reading is known as the Final Gravity (FG). The FG of a fast ferment sweet finish fruit wine should be about 1.019, which translates to an ABV of 8.01% and a residual sugar content of 49.65 g/L (4.965% sugar by volume).

Next, the fruit wine is tasted. If the FG is at the desired level, the lees, or deposits of dead yeast or residual yeast and other particles that precipitate, or are carried by the action of “fining”, to the bottom of a vat of wine after fermentation and aging, are removed and the fruit wine is transferred into glass carboys. The glass carboys are moved into a refrigerator and are stored below about 50° F. or 10° C. for about 72 hours. If the FG is too high, fermentation is allowed to continue until a desired level is reached.

### Method of First Racking

In a preferred embodiment of the present invention, the method of first racking comprises the following equipment: a sanitizing solution; glass carboys; air-locks; an anti-gravity transfer pump; a campden tablet and potassium sorbate as a stabilizer. About 72 hours after fermentation is completed, the method comprises the following steps: sanitizing all equipment, removing the fermentation vessel from the refrigerator, and taking the FG. The FG should be about 1.019.

Next, the method includes: tasting the wine, transferring the fruit wine into new glass carboys while leaving behind all lees, adding crushed campden tablets (e.g., about 1 per 5 gallons or 18.92 L of fruit wine), adding potassium sorbate (e.g., about 1 tsp or 4.2 grams per 5 gallons or 18.92 L of fruit wine), attaching an airlock and bung, and letting the solution sit for a time period of about 7 days to about 14 days.

### Method of Bottling

In a preferred embodiment of the present invention, the method of bottling comprises the following equipment: a sanitizing solution; bottles; corks; a corking machine; an anti-gravity transfer pump; and potassium sorbate as a stabilizer. The method of bottling comprises the following steps: sanitizing all equipment, soaking corks in the sanitizing liquid, and taking the FG. The FG should be about 1.019.

Next, the method includes: tasting the wine, transferring the wine into the bottles and filling each bottle to a neck while leaving about 1 inch of space below the cork, inserting the corks into the corking machine, corking the wine, and storing the bottles upright for about 7 days. Next, the bottles are stored on their side, allowing the fruit wine to soak the cork of each bottle. The bottles are aged for a desired time period.

### Example 2

In a preferred embodiment of the present invention, the method of creating a fruit wine with a dry finish generally comprises a first process step of preparing the fruit and a second process step of preparing the fruit wine. In this preferred embodiment of the present invention, the equipment comprises: a sanitization solution; fermentation buckets, preferably sized at about 2 gallons or 7.57 L and about 7.9 gallons or 29.90 L; mesh strainer bags; a wooden spoon; a potato masher; measuring cups and funnels.

In this preferred embodiment, components comprise: fruit, preferably about 5 lbs. per gallon water); sugar, preferably about 0.5 to 1 lb. (or 226.79 grams to 453.59 grams) per lb. fruit, although this varies by fruit; water; white raisins, preferably about 0.5 lb. (or 226.79 grams) per gal water; campden tablets; yeast nutrient; an acid blend; a tannin blend, although this optional; and a pectic enzyme.

The method of this preferred embodiment comprises the following steps:

### Day 1

On Day 1, the fruit is thawed for about 1 to about 2 hours. All equipment is then sanitized and allowed to soak in a solution for about 60 seconds. The solution may comprise an acid-based, no-rinse, and contact sanitizer. Next, water is brought to a boil (e.g., 1.75 gal per 2-gal or 6.62 L per 7.57 L; 6.5 gal per 7.9 gal or 24.61 L per 29.90 L). Once the water has begun to boil, sugar is added to the water and the water is stirred until the sugar dissolves. Sugar is added to adjust the initial sugar content of fruit to an acceptable and fermentable level. Once the sugar is dissolved, fruit is added to mesh bags and then the mesh bags containing the fruit are placed into a fermenter.

Next, white raisins are added to provide body to the fruit wine. The white raisins can improve the mouth-feel of the wine by increasing its viscosity. This gives the wine a heartier, overall impression. It also causes the fruit flavors to linger on the tongue longer, producing a fruitier impression.

Then, boiling water is poured over the fruit and let steep for about 30 minutes. The fruit is then macerated using a potato masher. The skins are broken to release the fruit juices. The fruit solids should not be mashed into a smooth consistency. This is let sit for about 1 hour.

About 1 crushed campden tablet is added per gallon (or 3.78 L) of the fruit wine. The campden tablet is a potassium or sodium metabisulfite tablet used to sterilize the fruit wine. The campden tablet releases sulfur into the solution, killing bacteria and inhibiting the growth of wild yeasts.

Next, a yeast nutrient, a yeast energizer, and a tannin blend (optional) is added (e.g., 1 tsp or 4.2 grams per gallon). The yeast nutrient and the yeast energizer include nutrients necessary for yeast growth and survival that might not be found at adequate levels in non-grape fruits. Tannins are naturally occurring polyphenol compounds found inside grape skins, seeds and stems. The polyphenols release from the skins, seeds and stems when they soak in the grape juice just after the grapes have been pressed and are responsible for the characteristic dryness or astringency of wines particularly red wines.

Then, about 0.5 tsp or 2.1 grams of an acid blend is added per gallon. The acid blend is a blend of tartaric, malic and citric acids used to adjust the pH of the wine to the acceptable range of about 2.5 to about 4.5. For non-grape white wines, the titratable acidity is in a range of about 0.55% to about 0.65%. For non-grape red wines, the titratable acidity is in a range of about 0.50% to about 0.60%.

Then, about 0.5 tsp or 2.1 grams of pectic enzyme is added per gallon. The pectic enzyme physically breaks down pectins, a polysaccharide found in plant cell walls, which constitute the “fleshy” part of most fruits such as grapes, and apples. Adding it to a wine must break down the pulp, making pressing more efficient. This sits overnight loosely covered with a paper towel soaked in a sanitizer.

In this preferred embodiment of the present invention, the method of primary fermentation requires equipment, such as: a sanitization solution; airlocks; a measuring cup; a graduated cylinder; a hydrometer; a funnel; a cup and a spoon. In this preferred embodiment of the present invention, the ingredients comprise: yeast, wine and sugar. In this preferred embodiment, the method of primary fermentation comprises the following steps:

### Day 2

On Day 2, the equipment is sanitized first and about 1 to about 1.5 cups (or 0.24 L to 0.36 L) of fruit wine are removed. These are microwaved for about 30 seconds until warmed to a temperature of about 100° F. or 37.77° C. Next, about 2 tbsp (or 25 grams) of sugar is added and stirred into the warm wine.

Next, 1 packet of yeast is added per 5 gallons or 18.93 L of the fruit wine. The yeast is allowed to rehydrate for about 30 minutes, where the fruit wine will become bubbly and frothy as the yeast rehydrates and begins to breathe. Next, the rehydrated yeast is transferred to a fermentation vessel. This sits for about 1 hour.

The hydrometer is used to take and record SG readings for each wine. This first SG reading is known as the Original Gravity (OG). The OG of a dry finish fruit wine should be about 1.100. More sugar may be added as needed to bring the OG to the desired reading.

### Days 3-14

First, all equipment is sanitized and a cap is punched about every 12 hours. Stirring then occurs to reoxygenate the fruit wine. Next, the fruit wine is left to ferment for about 5 days. On Day 8, fruit solids are removed and either frozen for future use or disposed of for composting. Also, on Day 8, SG readings are taken. This second SG reading is known as the Final Gravity (FG). The FG of a dry finish fruit wine should be about 0.990. This translates to an ABV of about 13.5-14.44% with little to no residual sugar content.

Next, the wine is tasted. If the FG is at the desired level, the lees is poured offer and the fruit wine is transferred into glass carboys. If the FG is too high, fermentation is allowed to continue until the desired level is reached, testing the FG every other day.

### Method of First Racking

In this preferred embodiment of the present invention, the method of first racking comprises the following equipment: a sanitizing solution; glass carboys; air-locks; an anti-gravity transfer pump; campden tablets and potassium sorbate as a stabilizer. Once fermentation completes, the method of first racking comprises the following steps: sanitizing all equipment, measuring the FG (e.g., should be at about 0.990), tasting the fruit wine, transferring the fruit wine into a glass carboy while leaving behind all lees, adding about 1 crushed campden tablet per 5 gallons or 18.93 L of the fruit wine, adding about 1 tsp or 4.2 grams of potassium sorbate per 5 gallons or 18.93 6L of the fruit wine, attaching an airlock and bung and letting sit for about 7 to about 14 days, and aging the dry wines about 3 months in the glass carboy, protecting the fruit wine from light, heat and environment, while checking for contaminations.

### Method of Bottling

In this preferred embodiment of the present invention, the method of bottling comprises the following equipment: a sanitizing solution; bottles; corks; a corking machine; an anti-gravity transfer pump; and potassium sorbate as a stabilizer. The method of bottling comprises the following steps: sanitizing all equipment, soaking the corks in the sanitizing liquid, measuring the FG (where the FG should be about 0.990), tasting the fruit wine, and transferring the fruit wine into the bottles, such that each bottle is filled to a neck, leaving about 1 inch of space below the cork. The corks are then inserted into the corking machine and the wine is corked. Next, the bottles of the fruit wine are stored upright for about 7 days and are then stored on their side, allowing the fruit wine to soak the cork of each bottle. The fruit wine is aged in the bottles for a desired time.

### Example 3

In a preferred embodiment of the present invention, the method of creating a wine with a sour finish protocol comprises preparing the fruit and preparing the wine. This method allows for a higher concentration of titratable acids and then stressing the yeast such that the fruit wines will finish with a characteristic sour flavor reminiscent of sour beers. The method may also include the addition of Lactobacillus bacteria and Brettanomyces yeast during the fermentation process to enhance the sour character of the fruit wine. Lactobacillus is a genus of Gram-positive, aerotolerant anaerobes or microaerophilic, rod-shaped, non-spore-forming bacteria. Brettanomyces is a non-spore forming genus of yeast in the family Saccharomycetaceae.

The preparation of the fruit wine comprises the following equipment: a sanitization solution; fermentation buckets, preferably sized at about 2 gallons and about 7.9 gallons (or 7.57 L and about 29.91 L); mesh strainer bags; a wooden spoon; a potato masher; measuring cups and funnels. The formulation comprises the following materials: fruit, preferably about 5 lbs. (or 2267 grams) per gallon water; sugar, preferably about 0.5 to about 1 lb. (or 226 grams to about 453 grams) per lb. fruit, although this varies by fruit; water; white raisins, preferably about 0.5 lb. (or 226 grams) per gallon water; campden tablets; a yeast nutrient; an acid blend; a tannin blend, although this may be optional and a pectic enzyme.

This method of the present invention comprises the following steps:

### Day 1

On day 1, fruit is thawed for about 1 to about 2 hours. Next, all equipment is sanitized and allowed to soak in a sanitizing solution for about 60 seconds and then set aside on clean towel to dry. The solution is an acid-based, no-rinse, contact sanitizer. Next, water is brought to a boil (e.g., about 1.75 gal per 2-gal or 6.62 L per 7.57 L; 6.5 gal per 7.9 gal or 24.61 L per 29.90 L). Once the water has begun to boil, sugar is added to the water and the water is stirred until the sugar is dissolved. The sugar is added to adjust the initial sugar content of fruit to an acceptable and fermentable level. Once the sugar is dissolved, fruit is added to mesh bags then the mesh bags containing the fruit are placed into a fermenter.

Next, white raisins are added to provide body to the wine. They can improve the mouth-feel of the wine by increasing its viscosity. This gives the wine a heartier, overall impression. It also causes the fruit flavors to linger on the tongue longer, producing a fruitier impression. Next, boiling water is poured over the fruit and let steep for about 30 minutes.

The fruit is then macerated using the potato masher. The potato masher breaks the skins of the fruit to release the juice from the fruits. The fruit solids should not be mashed into a smooth consistency. This sits for about 1 hour.

Then, about 1 crushed campden tablet is added per gallon of the fruit wine. The campden tablet is a potassium or sodium metabisulfite tablet used to sterilize the wine. The campden tablets release sulfur into solution killing bacteria and inhibiting the growth of wild yeasts.

Next, about 1 tsp or 4.2 grams of a yeast nutrient, a yeast energizer, and tannin blend (optional) are added per gallon. The yeast nutrient and the yeast energizer include nutrients necessary for yeast growth and survival that might not be found at adequate levels in non-grape fruits. Tannins are naturally occurring polyphenol compounds found inside grape skins, seeds and stems. The polyphenols release from the skins, seeds and stems when they soak in the grape juice just after the grapes have been pressed and are responsible for the characteristic dryness or astringency of wines particularly red wines.

About 1 to about 2 tsp (or 4.2 grams to 8.4 grams) of an acid blend are added per gallon of the fruit wine. The acid blend is a blend of tartaric, malic and citric acids used to adjust the pH of the wine to the acceptable range of about 2.5 to about 3.5. For non-grape white wines, the titratable acidity is in a range of about 0.65% to about 0.75%. For non-grape red wines, the titratable acidity is in a range of about 0.60% to about 0.70%.

Then, about 0.5 tsp or 2.1 grams of pectic enzyme is added per gallon of the fruit wine. The pectic enzyme physically breaks down pectins, a polysaccharide found in plant cell walls, which constitute the “fleshy” part of most fruits such as grapes, and apples. Adding it to a wine must break down the pulp, making pressing more efficient. This sits overnight loosely covered with a paper towel soaked in sanitizer.

In this preferred embodiment of the present invention, the method of primary fermentation requires equipment which comprises: a sanitization solution; airlocks; a measuring cup; a graduated cylinder; a hydrometer; a funnel; a cup; a spoon and carboys. In this preferred embodiment of the present invention, the ingredients comprise: yeast, wine, and sugar. n this preferred embodiment, the method of primary fermentation comprises the following steps:

### Day 2

During Day 2, all equipment is sanitized and about 1 to about 1.5 cups (or 236.59 mL to 354.88 mL) of wine are removed. The removed wine is microwaved for about 30 seconds until the fruit wine reaches about 100° F. or about 37.77° C. Next, about 2 tbsp or 25 grams of sugar is added and stirred into the warm fruit wine. About 1 packet of yeast per five gallons or 18.93 L of wine is added. Next, the yeast is allowed to rehydrate for about 30 minutes. The fruit wine will become bubbly and frothy as the yeast rehydrates and begins to breathe. Next, the rehydrated yeast is transferred to a fermentation vessel and allowed to sit for about 1 hour.

The hydrometer is used to take and record SG readings for each wine. This first SG reading is known as the Original Gravity (OG). The OG of a sour finish fruit wine should be about 1.080. Additional sugar may be added as needed to bring the OG to the desired reading.

### Days 3-8

The equipment is sanitized and caps are punched every 12 hours. The fruit wine is stirred to reoxygenate the fruit wine. The fruit wine is left to ferment for about 5 days. On Day 8, the fruit solids are removed and are either frozen for future use or disposed of for composting. Further, on Day 8, a second SG reading is taken, known as the Final Gravity (FG). The FG of a sour finish fruit wine should be about 1.019. This translates to an ABV of about 8.01% and a residual sugar content of about 49.65 g/L (or about 4.965% sugar by volume).

Next, the fruit wine is tasted. If the FG is at the desired level, the fruit wine is transferred to a refrigerator. The fruit wine is stored below about 50° F. or 10° C. for about 72 hours. As the yeast is stressed by a drop in a temperature, the yeast will produce esters and polyphenols, resulting in a characteristic sour flavor similar to a sour beer. If the FG is too high, the fermentation is allowed to continue until a desired level is reached.

### Method of First Racking

In this preferred embodiment of the present invention, the method of first racking comprises the following equipment: a sanitizing solution; glass carboys; air-locks; an anti-gravity transfer pump; campden tablets and potassium sorbate as a stabilizer. About 72 hours after fermentation completes, the method of first racking comprises the following steps: sanitizing all equipment, removing the fermentation vessel from the refrigerator, and measuring the FG. The FG should be at about 1.019. Next, the wine is tasted and transferred into a new glass carboy, leaving behind all lees. Then, about 1 crushed campden tablet is added per 5 gallons or 18.92 L of the fruit wine. Moreover, about 1 tsp or 4.2 grams of potassium sorbate is added per 5 gallons or 18.93 L of the fruit wine. Then, attachment of the airlock and bung occurs and the fruit wine sits for about 7 days to about 14 days.

### Method of Bottling

In this preferred embodiment of the present invention, the method of bottling comprises the following equipment: a sanitizing solution; bottles; corks; a corking machine; an anti-gravity transfer pump; and potassium sorbate as a stabilizer. The method of bottling comprises the following steps: sanitizing all equipment, soaking corks in sanitizing liquid, and measuring the FG. The FG should be about 1.019. Next, the wine is tasted and transferred into the bottles, filling each bottle to the neck, leaving about 1 inch of space below the cork. The corks are then inserted into the corking machine. The wine is then corked. The bottles of the fruit wine are stored upright for about 7 days and are then stored on their side, allowing the fruit wine to soak the cork. The fruit wine is aged in the bottles for a desired time.

In another embodiment of the present invention, yeast genetics with the aim of producing proprietary yeast strains capable of yielding high levels of organic compounds such as terpenes and polyphenols are studied. In another embodiment of the present invention, genetically engineered yeast strains are created to produce wines with inherent health benefits. These bioactive phytochemicals can have antioxidant effects, reduce inflammation, reduce blood pressure and reduce cholesterol, as well as provide cardio- and neuro-protective effects. In another embodiment of the present invention, yeast strains are used to best preserve the natural fruit characteristics of wines via the production of esters to enhance the fruity aromas and flavors inherent in wines. This can be accomplished via genetic engineering, crossbreeding, metabolic engineering, genomic and metabolomic screening, and the pitching of multiple strains of yeast into a single wine.

Although the invention has been explained in relation to its preferred embodiment, it is to be understood that many other possible modifications and variations can be made without departing from the spirit and scope of the invention.

What is claimed is:

1. A method for preparing an alcoholic fruit wine from food waste, the method comprising:
boiling raw fruit;
crushing the raw fruit;
transferring a crushed raw fruit pulp to a fermentation vessel;
inoculating the crushed raw fruit pulp with a yeast to allow an initial fermentation to proceed within the fermentation vessel;
separating fermented wine liquid from a solid fruit residue; and
allowing the fermented wine liquid to undergo a secondary fermentation in a new fermentation vessel to create an alcoholic fruit wine.

2. The method of claim 1, wherein, prior to the boiling of the raw fruit, the method further comprises:
inspecting the raw fruit; and
discarding a subset of the raw fruit having an appearance of mold or a contamination.

3. The method of claim 2, further comprising:
freezing the raw fruit to break down cell walls of the raw fruit;
storing the raw fruit; and
thawing the raw fruit prior to use.

4. The method of claim 1, wherein the food waste is selected from the group consisting of:
agricultural food waste, commercial food waste, and consumer food waste.

5. The method of claim 1, wherein the raw fruit is selected from the group consisting of:
pomegranates, apples, pears, blueberries, blackberries, strawberries, raspberries, banana, pumpkins, mangos, watermelons, honeydew melons, and cantaloupes.

6. The method of claim 1, wherein, in response to inoculating the crushed raw fruit pulp with the yeast to allow the initial fermentation to proceed within the fermentation vessel, the method further comprises:
adjusting a dissolved sugar content based on specific gravity to produce the alcoholic fruit wine having an alcohol by volume (ABV) in a range between about 7% to about 20%.

7. The method of claim 1, wherein a temperature range for the initial fermentation is between about 10° C. to about 50° C.

8. The method of claim 7, wherein the temperature range for the initial fermentation is between about 15° C. to about 34° C.

9. The method of claim 1, wherein a time period for the initial fermentation is between about 7 days to about 30 days.

10. The method of claim 1, further comprising:
determining a completion of the primary fermentation by detecting that the alcoholic fruit wine has reached a predetermined alcohol by volume (ABV) based on a specific gravity reading taken using a hydrometer and based on a detected decrease in a fermentation activity via a visual inspection.

11. The method of claim 1, wherein a temperature range for the secondary fermentation is in a range between about 10° C. to about 50° C.

12. The method of claim 11, wherein the temperature range for the secondary fermentation is in the range between about 15° C. to about 34° C.

13. The method of claim 1, wherein a time period for the secondary fermentation is between about 14 days to about 28 days.

14. The method of claim 1, further comprising:
inspecting the alcoholic fruit wine.

15. The method of claim 14, further comprising:
bottling the alcoholic fruit wine.

16. A formulation for producing an alcoholic fruit wine, the formulation comprising:
a predetermined amount of raw fruit;
a predetermined amount of sugar;
a predetermined amount of water;
a predetermined amount of white raisins;
a predetermined amount of campden tablets;
a predetermined amount of yeast nutrients;
a predetermined amount of an acid blend; and
a predetermined amount of a tannin blend.

17. The formulation of claim 16, further comprising:
a predetermined amount of a pectic enzyme.

18. The formulation of claim 16, wherein the predetermined amount of the raw fruit is more than about 2000 grams.

19. The formulation of claim 16, wherein the predetermined amount of the sugar is between about 200 grams to about 500 grams per pound of the raw fruit.

20. The formulation of claim 16, wherein the predetermined amount of the white raisins is more than 200 grams per gallon of the water.
